(19) United States
(12) Patent Application Publication
(10) Pub. No.: US 2011/0053768 A1
(43) Pub. Date: Mar. 3, 2011

(54) RECORDING MATERIAL FOR LASER MARKING

(75) Inventors: André Becker, Kreuzau (DE); Klaus Hoeffgen, Kreuzau (DE); Theo Pütz, Heimbach (DE); Günther Röthel, Aldenhoven (DE); Viktor Uerlings, Duren (DE)

(73) Assignee: M-real Oyj, Espoo (FI)

(21) Appl. No.: 12/868,569

(22) Filed: Aug. 25, 2010

(30) Foreign Application Priority Data
Aug. 26, 2009 (EP) 09010891.1

(51) Int. Cl. B41M 5/327; B32B 37/00; B41M 5/30; B41M 5/333; B41M 5/323; B41M 5/337

(52) U.S. Cl. 503/201; 156/60; 503/200; 503/216; 503/221; 503/218

(57) ABSTRACT

Disclosed herein in a preferred embodiment is a recording material comprising a substrate and a coating comprising at least 3 plies, wherein the outermost ply contains nanoparticles and the inner plies together contain at least one color former, at least one color developer, at least one absorber and at least one solubilizer, and no ply contains both a color former and a color developer. Also disclosed is a process for producing the recording material of the invention and also to a laser marking process wherein the recording material is irradiated with a laser.

### CROSS-REFERENCE TO RELATED APPLICATIONS

This application claims the benefit of European Patent Application Number 09 010 891.1 filed on Aug. 26, 2009, the disclosure of which is hereby expressly incorporated by reference in its entirety and hereby expressly made a portion of this application.

### BACKGROUND OF THE INVENTION

1. Field of the Invention

The present invention relates to a recording material comprising a substrate and a coating comprising at least 3 plies, wherein the outermost ply contains nanoparticles and the inner plies together contain at least one color former, at least one color developer, at least one absorber and at least one solubilizer, and no ply contains both a color former and a color developer.

The invention further relates to a process for producing the recording material of the invention and also to a laser marking process wherein the recording material of the invention is irradiated with a laser.

2. Description of the Related Art

Thermosensitive recording materials designed to produce color images as a result of a color forming reaction between a color former and a color developer which are present alongside each other in a coating coming into contact on heating the thermosensitive recording material are known.

The general method of making a recording on the thermosensitive recording material involves a recording head (a thermal head) touching the recording layer of the thermosensitive material. Problems can arise with this method, for example wear of the head, adherence of dust or other particles to the tip of the head and sticking of the head to the recording layer. In addition, the method is not suitable for high-speed recordings since the recording speed depends on the heat dissipation time of the thermal head, and the resolution of the color images is limited by diffusion of heat. Therefore, instead of the contact method involving the use of a thermal head, various no-contact recording methods have been proposed, which use a laser or similar beam of light for recording.

DE 33 40 945 A1, for instance, describes the use of IR laser radiation to provide the necessary heat for the color forming reaction. IR laser radiation is also used according to EP 0 637 514 A1, wherein the color developing coating additionally includes an inorganic substance, known as an absorber, said to improve the absorption of the infrared radiation.

However, the recording materials used in the marking processes described have the disadvantage that they are very sensitive to unwanted color reactions. Often mere finger perspiration will lead to unwanted color reactions on touching the recording materials. Moreover, the recording materials are not stable in storage.

### SUMMARY

Disclosed is a recording material comprising a substrate and a coating, said the coating comprising at least 3 plies, wherein an outermost ply may comprise nanoparticles and inner plies together may comprise at least one color former, at least one color developer, at least one absorber absorbing radiation in a wavelength range from 800 nm to 2000 nm and at least one solubilizer, and no ply may comprise both a color former and a color developer. In some embodiments, the recording material may be characterized in that the at least one absorber absorbs electromagnetic radiation in a wavelength range from 800 nm to 2000 nm. In some other embodiments, the recording material may be characterized in that the at least one absorber is selected from the group consisting of organic and inorganic compounds having an absorption of >60% of an incident energy. In still some other embodiments, the recording material may be characterized in that the at least one color developer is selected from the group consisting of bentonite and zinc salts of salicylic acid compounds and zinc salts of phenol compounds.

In some embodiments, the recording material may be characterized in that the at least one color former is selected from the group consisting of fluorans, lactams, spiro compounds and triarylmethane compounds. In addition, the recording material may be characterized in that the nanoparticles have an average particle diameter of 10 to 300 nm.

In certain embodiments, the recording material may be characterized in that the nanoparticles are selected from the group consisting of colloidal silica, china clay, titanium dioxide, zinc oxide, precipitated barium sulfate, tin oxide, precipitated calcium carbonate and alumina. In addition, the recording material may be characterized in that the coating further comprises at least one pigment and/or at least one binder.

Further, the recording material may be characterized in that the substrate is selected from the group consisting of fibrous materials, plastics and metals. In some embodiments, the recording material may be characterized in that the substrate is paper or card. In addition, the recording material may be characterized in that the substrate has a basis weight of 40 to 400 g/m².

Also disclosed is a process for producing a recording material. The process may comprises applying said coating comprising at least 3 plies to at least part of the substrate, wherein the outermost ply may comprise nanoparticles and the inner plies together may comprise at least one color former, at least one color developer, at least one absorber and at least one solubilizer, and no ply may comprise both a color former and a color developer. In some embodiments, the process may be characterized in that a coat weight of the coating on the substrate is between 1 and 10 g/m².

Also disclosed is a laser marking process, which may comprise providing a recording material, and irradiating the recording material with a laser. In some embodiments, the process may be characterized in that the irradiating the recording material is effected using a fiber laser, an Nd:YAG laser or a diode laser.

### DETAILED DESCRIPTION OF THE EMBODIMENTS

It is an object of the present invention to provide a recording material that surmounts the disadvantages of the prior art, more particularly the aforementioned sensitivity to unwanted color reactions and the lack of stability in storage.

It has now been found that, surprisingly, the aforementioned disadvantages of the prior art are surmounted when the color developing coating contains color former and color developer in separate layers, i.e., at different locations, and additionally a protective layer containing nanoparticles is provided on the color developing coating.

The present invention accordingly provides a recording material comprising a substrate and a coating comprising at least 3 plies, wherein the outermost ply contains nanoparticles and the inner plies together contain at least one color former, at least one color developer, at least one absorber and at least one solubilizer, and no ply contains both a color former and a color developer, and also a process for producing this recording material. The present invention further provides a laser marking process wherein the recording material of the present invention is irradiated with a laser.

As mentioned, the subject matter of the present invention includes inter alia the feature that the color developing coating contains at least one substance that absorbs radiation of a certain wavelength and converts it into thermal energy (substance known as an absorber). This thermal energy initiates a chemical reaction between a color former and a color developer in the color developing coating of the recording material, which then leads to a color reaction. By using an energy absorber in a defined wavelength range (e.g., 800 nm to 2000 nm), lasers other than the infrared lasers typically used can be used, examples being fiber lasers, Nd:YAG lasers or diode lasers.

In a preferred embodiment, the absorber absorbs electromagnetic radiation in a wavelength range from 800 nm to 2000 nm. An absorbing substance can be any organic or inorganic compound having an absorption, preferably of above 60 percent of the incident energy, in the desired wavelength range. Examples of suitable absorbing substances are the following: mica coated with antimony-doped tin oxide (“Lazerflair” from Merck), copper hydroxyphosphate (“Budit 322” from Budenheim), iridium tin oxide (“Adnano ITO” from Evonik-Degussa), phlegmatized aluminum powder (“MaG-6-10” from Eckart), perylene derivatives (“Lumogen” from BASF), phthalocyanines (“PRO-JET” from Fujifilm). But in addition, combinations of one or more absorbers with one or more solubilizers in the form of a microencapsulated system are also possible.

The use of the absorbing substance can be in any desired amount, but preferably the absorber is included at 0.1 to 10 parts based on the overall color developing composition.

Which color forming systems are used according to the present invention is not decisive provided the at least one color former and the at least one color developer are present in such a combination that they undergo a color forming reaction by the action of heat once contacted with each other.

Examples of combinations which can be used are the combination of a colorless or weakly colored basic color former and an organic or inorganic acidic color developer and the combination of iron(III) stearate or a similar metal salt of a higher fatty acid and gallic acid or a similar phenol compound without being limited thereto. The present invention can also be applied to the various thermosensitive recording materials in which a diazonium compound, a coupler and a basic color developer are used in combination to produce colored images (recordings) by the thermal route.

When the absorbing substance used according to the present invention is used, for example, in a combination of a basic color former and of an acidic color developer in addition to other combinations, this substance demonstrates an extraordinarily potent efficacy in respect of improving recording sensitivity. The use of the abovementioned combination of a basic color former and of an acidic color developer is therefore particularly preferred.

Examples of usable colorless or weakly colored basic dyes which are already known include: dyes based on triarylmethane, for example 3,3-bis(p-dimethylaminophenyl)-6-dimethylaminophthalide, 3,3-bis(p-dimethylaminophenyl)phthalide, 3-(p-dimethylaminophenyl)-3-(1,2-dimethylindol-3-yl)phthalide, 3-(p-dimethylaminophenyl)-3-(2-methylindol-3-yl)phthalide, 3,3-bis(1,2-dimethylindol-3-yl)-5-dimethylaminophthalide, 3,3-bis(1,2-dimethylindol-3-yl)-6-dimethylaminophthalide, 3,3-bis(9-phenylindol-3-yl)-6-dimethyl-aminophthalide, 3-p-dimethylaminophenyl-3-(1-methylpyrrol-3-yl)-6-dimethylaminophthalide; dyes based on diphenylmethane, for example 4,4′-bisdimethylaminobenzhydryl benzyl ether, N-halophenylleucoauramine, N-2,4,5-trichlorophenylleucoauramine; dyes based on thiazine, for example benzoyl leuco methylene blue, p-nitrobenzoyl leuco methylene blue; dyes based on spiro compounds, for example 3-methylspirodinaphthopyran, 3-ethylspirodinaphthopyran, 3-phenylspirodinaphthopyran, 3-benzylspirodinaphthopyran, 3-methylnaphtho-(6′-methoxybenzo)spiropyran, 3-propylspirodibenzopyran; dyes based on lactams, for example rhodamine B anilinolactam, rhodamine (p-nitroanilino)lactam, rhodamine (o-chloroanilino)lactam; dyes based on fluoran, for example 3,6-dimethoxyfluoran, 3,6-diethoxyfluoran, 3,6-dibutoxyfluoran, 3-dimethylamino-7-methoxyfluoran, 3-diethylamino-6-methoxyfluoran, 3-diethylamino-7-methoxyfluoran, 3-diethylamino-7-chlorofluoran, 3-diethylamino-6-methyl-7-chlorofluoran, 3-diethylamino-6,7-dimethylfluoran, 3-(N-ethyl-p-toluidino)-7-methylfluoran, 3-diethylamino-7-(N-acetyl-N-methylamino)fluoran, 3-diethylamino-7-N-methylaminofluoran, 3-diethylamino-7-dibenzylaminofluoran, 3-diethylamino-5-methyl-7-dibenzylaminofluoran, 3-diethylamino-7-(N-methyl-N-benzylamino)fluoran, 3-diethylamino-7-(N-chloroethyl-N-methylamino)fluoran, 3-diethylamino-7-diethylaminofluoran, 3-(N-ethyl-p-toluidino)-6-methyl-7-phenylaminofluoran, 3-(N-ethyl-p-toluidino)-6-methyl-7-(p-toluidino)fluoran, 3-diethylamino-6-methyl-7-phenylaminofluoran, 3-diethylamino-7-(2-carbomethoxyphenylamino)fluoran, 3-(N-ethyl-N-isoamylamino)-6-methyl-7-phenylaminofluoran, 3-(N-cyclohexyl-N-methylamino)-6-methyl-7-phenylaminofluoran, 3-pyrrolidino-6-methyl-7-methylaminofluoran, 3-piperidiono-6-methyl-7-phenylaminofluoran, 3-diethylamino-6-methyl-7-xylidinofluoran, 3-diethylamino-7-(o-chlorophenylamino)fluoran, 3-dibutylamino-7-(o-chlorophenylamino)fluoran, 3-pyrrolidino-6-methyl-7-p-butylphenylaminofluoran.

Examples of organic and inorganic acidic materials which can undergo a color forming reaction on contact with basic dyes are inorganic acidic materials such as activated clay, acidic clay, attapulgite, bentonite, colloidal silica and aluminum silicate, and organic acidic materials such as phenol compounds, for example 4-tert-butylphenol, 4-tert-octylphenol, 4-phenylphenol, 4-acetylphenol, α-naphthol, β-naphthol, hydroquinone, 2,2′-dihydroxybiphenyl, 2,2′-methylenebis(4-methyl-6-tert-butylphenol), 2,2′-methylenebis(4-chlorophenol), 4,4′-dihydroxydiphenylmethane, 4,4-isopropylidenediphenol, 4,4-isopropylidenebis(2-tert-butylphenol), 4,4″ sec-butylidenephenol, 4,4′-cyclohexylidenediphenol, 4,4′-dihydroxydiphenyl sulfide, 4,4′-thiobis(6-tert-butyl-3-methylphenol), 4,4′-dihydroxydiphenyl sulfone, benzyl 4-hydroxybenzoate, dimethyl 4-hydroxyphthalate, hydroquinone monobenzyl ether, novolak type phenolic resins and phenol polymers and also aromatic carboxylic acid compounds such as benzoic acid, p-tert-butylbenzoic acid, trichlorobenzoic acid, 3-sec-butyl-4-hydroxybenzoic acid, 3-cyclohexyl-4-hydroxybenzoic acid, 3,5-dimethyl-4-hydroxybenzoic acid, salicylic acid, 3-isopropylsalicylic acid, 3-tert-butylsalicylic acid, 3-benzylsalicylic acid, 3-(α-methylbenzyl)salicylic acid, 3-chloro-5-(α-methylbenzyl)salicylic acid, 3,5-di-tert-butylsalicylic acid, 3-phenyl-5-(α,α-dimethylbenzyl)salicylic acid, 3,5-di(α-methylbenzyl)salicylic acid and terephthalic acid. However, salts of such phenol compounds and aromatic carboxylic acids with polyvalent metals such as zinc, magnesium, aluminum, calcium, titanium, manganese, tin and nickel are also very useful according to the present invention.

The proportions of color former and color developer used to prepare the recording material of the present invention and incorporated into the color developing coating, are not decisive. When, for example, a combination of a colorless or weakly colored basic color former and an organic or inorganic acidic color developer is used, it is possible to use from 5 to 20 parts, preferably 10 to 15 parts, of the color developer and from 5 to 15 parts, preferably 10 parts, of the color former, based on the overall color developing composition. Similar ratios hold for all other possible combinations.

In general, these materials are formulated to form a color developing coating composition using water as dispersing medium and a stirring or pulverizing apparatus such as a ball mill, or an attritor or sand mill, by dispersing the two materials separately.

The specific absorbing substance (absorber) may be dispersed together with the at least one color former and/or the at least one color developer, or be added to the dispersions obtained.

Examples of nanoparticles to be used according to the present invention are nanoparticles of colloidal silica, china clay, tin(IV) oxide, precipitated barium sulfate, precipitated calcium carbonate, alumina, titanium dioxide (rutile and anatase) and zinc oxide.

The nanoparticles to be used according to the present invention preferably have an average particle diameter in the range from 10 nm to 300 nm, more preferably in the range from 20 nm to 100 nm and most preferably in the range from 30 nm to 70 nm.

The color developing coating of the present invention contains a solubilizer which is melted by the thermal energy released by the absorber, and then dissolves both the color former and the color developer, which thereby come into contact with each other and can react with each other in a color reaction. Examples of suitable solubilizers are p-benzylbiphenyl (PBBP), 2-benzyloxynaphthalene (BON), di(p-methylbenzyl) oxalate, diisopropylnaphthalene. It is also possible for the solubilizers to be present as a microencapsulated system.

The color developing coating usually contains a binder, such as starches, hydroxyethylcellulose, methylcellulose, carboxymethylcellulose, gelatin, casein, gum arabic, polyvinyl alcohol, styrene-maleic anhydride copolymer salts, styrene-acrylic acid copolymer salts, styrene-butadiene copolymer emulsions or the like. The binder is advantageously used in amounts of 5 to about 25 parts, preferably in amounts of about 10 to 20 parts, based on the overall composition.

The color developing coating usually also contains a pigment, such as calcium carbonate, china clay, calcined clay, aluminum hydroxide, barium sulfate, titanium dioxide.

The color developing coating may also include various auxiliaries in admixture. Examples of advantageous auxiliaries are dispersants such as sodium dioctyl sulfosuccinate, sodium dodecylbenzenesulfonate, sodium lauryl sulfate and metal salts of fatty acids; UV-absorbing agents of the benzophenone and triazole types or similar species, defoaming agents, fluorescent dyes, colorants and the like, without being limited thereto.

In a preferred embodiment, the substrate is selected from the group consisting of fibrous materials, plastics and metals. In a particularly preferred embodiment, the substrate is paper or card. It is very particularly preferable for the substrate to have a basis weight of 40 to 400 g/m2.

The present invention further provides a process for producing the recording material of the present invention, wherein a coating comprising at least 3 plies, wherein the outermost ply contains nanoparticles and the inner plies together contain at least one color former, at least one color developer, at least one absorber and at least one solubilizer, and no ply contains both a color former and a color developer, is applied to at least part of the substrate.

In a preferred embodiment of the process of the present invention, the coat weight of the coating on the substrate is between 1 and 60 g/m2. It is more preferable for the coat weight of the coating on the substrate to be between 3 and 20 g/m2.

The present invention also provides a laser marking process wherein the color developing coating of the recording material of the present invention is irradiated with a laser.

In a preferred embodiment of the process of the present invention, irradiating the color developing coating is effected using a fiber laser, an Nd:YAG laser or a diode laser. However, irradiation with a CO2 laser is also possible.

### EXAMPLES

Embodiments of the present invention will now be more particularly described by way of example.

### Example 1

1^{st} coating

| | |
|---|---|
| 5 to 40 parts of color former | Pergascript Black 2C, Ciba |
| 0.1 to 20 parts of absorber | Lazerflair, Merck |
| 30 to 60 parts of calcined clay | Ansilex 93, BASF |
| 10 to 20 parts of calcium carbonate | Hydrocarb 60, Omya |
| 5 to 20 parts of binder | PVA and latex |
| 0.05 to 0.5 part of wetter | Wallasol DIO 60 PG, Wall Chemie |
| Add-on weight 1.0 to 5.0 g/m² | |

2^{nd} coating

| | |
|---|---|
| 50 to 70 parts of calcium carbonate | Hydrocarb 60, Omya |
| 10 to 20 parts of color developer | ER-054, Sanko |
| 1 to 5 parts of CMC | Finnfix 2000, CB Kelco |
| 1 to 10 parts of PVA | Mowiol 20/98, Kuraray |
| 10 to 20 parts of binder | Litex P 5100, Polymerlatex |
| Add-on weight 2.0 to 6.0 g/m² | |

3^{rd} coating

| | |
|---|---|
| 20 to 50 parts of binder | Mowiol 20/98, Kuraray |
| 50 to 80 parts of colloidal silica | Ludox CL, Grace |
| Add-on weight 1.0 to 6.0 g/m² | |

### Example 2

1^{st} coating

| | |
|---|---|
| 5 to 40 parts of color former | Pergascript Black 2C, Ciba |
| 0.1 to 20 parts of absorber | Fabulase 322, CFB Budenheim |
| 30 to 60 parts of calcined clay | Ansilex 93, BASF |
| 10 to 20 parts of calcium carbonate | Hydrocarb 60, Omya |
| 5 to 20 parts of BNE | benzyl naphthyl ether, Clariant |
| 5 to 20 parts of binder | PVA and latex |
| 0.05 to 0.5 part of wetter | Wallasol DIO 60 PG, Wall Chemie |
| Add-on weight 1.0 to 5.0 g/m² | |

2^{nd} coating

| | |
|---|---|
| 50 to 70 parts of calcium carbonate | Hydrocarb 60, Omya |
| 10 to 20 parts of color developer | ER-054, Sanko |
| 1 to 5 parts of CMC | Finnfix 2000, CB Kelco |
| 1 to 10 parts of PVA | Mowiol 20/98, Kuraray |
| 10 to 20 parts of binder | Litex P 5100, Polymer latex |
| Add-on weight 2.0 to 6.0 g/m² | |

3^{rd} coating

| | |
|---|---|
| 20 to 50 parts of binder | Mowiol 20/98, Kuraray |
| 50 to 80 parts of china clay | M 07-1061, BASF |
| Add-on weight 1.0 to 6.0 g/m² | |

### Example 3

1^{st} coating

| | |
|---|---|
| 5 to 40 parts of color former | Pergascript Black 2C, Ciba |
| 0.1 to 20 parts of absorber | Projet 925, Fujifilm |
| 30 to 60 parts of calcined clay | Ansilex 93, BASF |
| 10 to 20 parts of calcium carbonate | Hydrocarb 60, Omya |
| 5 to 20 parts of binder | PVA and latex |
| 0.05 to 0.5 part of wetter | Wallasol DIO 60 PG, Wall Chemie |
| Add-on weight 1.0 to 5.0 g/m² | |

2^{nd} coating

| | |
|---|---|
| 50 to 70 parts of calcium carbonate | Hydrocarb 60, Omya |
| 10 to 20 parts of color developer | Durez 33140, Sumitomo Bakelite |
| 1 to 5 parts of CMC | Finnfix 2000, CB Kelco |
| 1 to 10 parts of PVA | Mowiol 20/98, Kuraray |
| 10 to 20 parts of binder | Litex P 5100, Polymer latex |
| Add-on weight 2.0 to 6.0 g/m² | |

3^{rd} coating

| | |
|---|---|
| 20 to 50 parts of binder | Mowiol 20/98, Kuraray |
| 50 to 80 parts of colloidal silica | Sylojet 400 C, Grace |
| Add-on weight 1.0 to 6.0 g/m² | |

### Example 4

1^{st} coating

| | |
|---|---|
| 5 to 40 parts of color former | Pergascript Black 2C, Ciba |
| 0.1 to 20 parts of absorber | Lazerflair, Merck |
| 30 to 60 parts of calcined clay | Ansilex 93, BASF |
| 10 to 20 parts of calcium carbonate | Hydrocarb 60, Omya |
| 5 to 20 parts of binder | PVA and latex |
| 0.05 to 0.5 part of wetter | Wallasol DIO 60 PG, Wall Chemie |
| Add-on weight 1.0 to 5.0 g/m² | |

2^{nd} coating

| | |
|---|---|
| 50 to 70 parts of calcium carbonate | Hydrocarb 60, Omya |
| 10 to 20 parts of color developer | ER-054, Sanko |
| 1 to 5 parts of CMC | Finnfix 2000, CB Kelco |
| 1 to 10 parts of PVA | Mowiol 20/98, Kuraray |
| 10 to 20 parts of binder | Litex P 5100, Polymerlatex |
| Add-on weight 2.0 to 6.0 g/m² | |

3^{rd} coating

| | |
|---|---|
| 50 to 80 parts of binder | Mowiol 20/98, Kuraray |
| 20 to 50 parts of titanium dioxide | Hombitec, Sachtleben |
| Add-on weight 1.0 to 6.0 g/m² | |

### Example 5

1^{st} coating

| | |
|---|---|
| 5 to 40 parts of color former | Pergascript Black 2C, Ciba |
| 0.1 to 20 parts of absorber | Lazerflair, Merck |
| 30 to 60 parts of calcined clay | Ansilex 93, BASF |
| 10 to 20 parts of calcium carbonate | Hydrocarb 60, Omya |
| 5 to 20 parts of binder | PVA and latex |
| 0.05 to 0.5 part of wetter | Wallasol DIO 60 PG, Wall Chemie |
| Add-on weight 1.0 to 5.0 g/m² | |

2^{nd} coating

| | |
|---|---|
| 50 to 70 parts of calcium carbonate | Hydrocarb 60, Omya |
| 10 to 20 parts of color developer | ER-054, Sanko |
| 1 to 5 parts of CMC | Finnfix 2000, CB Kelco |
| 1 to 10 parts of PVA | Mowiol 20/98, Kuraray |
| 10 to 20 parts of binder | Litex P 5100, Polymerlatex |
| Add-on weight 2.0 to 6.0 g/m² | |

3^{rd} coating

| | |
|---|---|
| 50 to 80 parts of binder | Mowiol 20/98, Kuraray |
| 20 to 50 parts of zinc oxide | Zincox, IBU |
| Add-on weight 1.0 to 6.0 g/m² | |

### Example 6

1^{st} coating

| | |
|---|---|
| 5 to 40 parts of color former | Pergascript Black 2C, Ciba |
| 0.1 to 20 parts of absorber | Lazerflair, Merck |
| 30 to 60 parts of calcined clay | Ansilex 93, BASF |
| 10 to 20 parts of calcium carbonate | Hydrocarb 60, Omya |
| 5 to 20 parts of binder | PVA and latex |
| 0.05 to 0.5 part of wetter | Wallasol DIO 60 PG, Wall Chemie |
| Add-on weight 1.0 to 5.0 g/m² | |

2^{nd} coating

| | |
|---|---|
| 50 to 70 parts of calcium carbonate | Hydrocarb 60, Omya |
| 10 to 20 parts of color developer | ER-054, Sanko |
| 1 to 5 parts of CMC | Finnfix 2000, CB Kelco |
| 1 to 10 parts of PVA | Mowiol 20/98, Kuraray |
| 10 to 20 parts of binder | Litex P 5100, Polymerlatex |
| Add-on weight 2.0 to 6.0 g/m² | |

3^{rd} coating

| | |
|---|---|
| 50 to 80 parts of binder | Mowiol 20/98, Kuraray |
| 20 to 50 parts of barium sulfate | Sachtoperse, Sachtleben |
| Add-on weight 1.0 to 6.0 g/m² | |

### Example 7

1^{st} coating

| | |
|---|---|
| 5 to 40 parts of color former | Pergascript Black 2C, Ciba |
| 0.1 to 20 parts of absorber | Lazerflair, Merck |
| 30 to 60 parts of calcined clay | Ansilex 93, BASF |
| 5 to 20 parts of solubilizer | BON, Clariant |
| 10 to 20 parts of calcium carbonate | Hydrocarb 60, Omya |
| 5 to 20 parts of binder | PVA and latex |
| 0.05 to 0.5 part of wetter | Wallasol DIO 60 PG, Wall Chemie |
| Add-on weight 1.0 to 5.0 g/m² | |

2^{nd} coating

| | |
|---|---|
| 50 to 70 parts of calcium carbonate | Hydrocarb 60, Omya |
| 10 to 20 parts of color developer | ER-054, Sanko |
| 1 to 5 parts of CMC | Finnfix 2000, CB Kelco |
| 1 to 10 parts of PVA | Mowiol 20/98, Kuraray |
| 10 to 20 parts of binder | Litex P 5100, Polymerlatex |
| Add-on weight 2.0 to 6.0 g/m² | |

3^{rd} coating

| | |
|---|---|
| 50 to 80 parts of binder | Mowiol 20/98, Kuraray |
| 20 to 50 parts of barium sulfate | Sachtoperse, Sachtleben |
| Add-on weight 1.0 to 6.0 g/m² | |

### Example 8

1^{st} coating

| | |
|---|---|
| 5 to 40 parts of color former | Pergascript Black 2C, Ciba |
| 0.1 to 20 parts of absorber | Lazerflair, Merck |
| 30 to 60 parts of calcined clay | Ansilex 93, BASF |
| 10 to 20 parts of calcium carbonate | Hydrocarb 60, Omya |
| 5 to 20 parts of binder | PVA and latex |
| 0.05 to 0.5 part of wetter | Wallasol DIO 60 PG, Wall Chemie |
| Add-on weight 1.0 to 5.0 g/m² | |

2^{nd} coating

| | |
|---|---|
| 50 to 70 parts of calcium carbonate | Hydrocarb 60, Omya |
| 5 to 20 parts of solubilizer | BON, Clariant |
| 10 to 20 parts of color developer | ER-054, Sanko |
| 1 to 5 parts of CMC | Finnfix 2000, CB Kelco |
| 1 to 10 parts of PVA | Mowiol 20/98, Kuraray |
| 10 to 20 parts of binder | Litex P 5100, Polymerlatex |
| Add-on weight 2.0 to 6.0 g/m² | |

3^{rd} coating

| | |
|---|---|
| 50 to 80 parts of binder | Mowiol 20/98, Kuraray |
| 20 to 50 parts of zinc oxide | Zincox, IBU |
| Add-on weight 1.0 to 6.0 g/m² | |

What is claimed is:

1. A recording material comprising a substrate and a coating, the coating comprising at least 3 plies, wherein an outermost ply comprises nanoparticles and inner plies together comprise at least one color former, at least one color developer, at least one absorber absorbing radiation in a wavelength range from 800 nm to 2000 nm and at least one solubilizer, and no ply comprises both a color former and a color developer.

2. The recording material according to claim 1, characterized in that the at least one absorber absorbs electromagnetic radiation in a wavelength range from 800 nm to 2000 nm.

3. The recording material according to claim 1, characterized in that the at least one absorber is selected from the group consisting of organic and inorganic compounds having an absorption of >60% of an incident energy.

4. The recording material according to claim 1, characterized in that the at least one color developer is selected from the group consisting of bentonite and zinc salts of salicylic acid compounds and zinc salts of phenol compounds.

5. The recording material according to claim 1, characterized in that the at least one color former is selected from the group consisting of fluorans, lactams, spiro compounds and triarylmethane compounds.

6. The recording material according to claim 1, characterized in that the nanoparticles have an average particle diameter of 10 to 300 nm.

7. The recording material according to claim 1, characterized in that the nanoparticles are selected from the group consisting of colloidal silica, china clay, titanium dioxide, zinc oxide, precipitated barium sulfate, tin oxide, precipitated calcium carbonate and alumina.

8. The recording material according claim 1, characterized in that the coating further comprises at least one pigment and/or at least one binder.

9. The recording material according to claim 1, characterized in that the substrate is selected from the group consisting of fibrous materials, plastics and metals.

10. The recording material according to claim 1, characterized in that the substrate is paper or card.

11. The recording material according to claim 1, characterized in that the substrate has a basis weight of 40 to 400 g/m².

12. A process for producing a recording material according to claim 1 comprising:
applying said coating comprising at least 3 plies to at least part of the substrate, wherein the outermost ply comprises nanoparticles and the inner plies together comprise at least one color former, at least one color developer, at least one absorber and at least one solubilizer, and no ply comprises both a color former and a color developer.

13. The Process according to claim 12, characterized in that a coat weight of the coating on the substrate is between 1 and 10 g/m².

14. A laser marking process comprising:
providing a recording material according to claim 1; and
irradiating the recording material with a laser.

15. The process according to claim 14, characterized in that the irradiating the recording material is effected using a fiber laser, an Nd:YAG laser or a diode laser.
